(19) United States
(12) Patent Application Publication
(10) Pub. No.: US 2015/0167513 A1
(43) Pub. Date: Jun. 18, 2015

(54) LUBRICATION SYSTEM FOR ENGINES

(71) Applicant: Caterpillar Inc., Peoria, IL (US)

(72) Inventor: Thomas R. McClure, Washington, IL (US)

(73) Assignee: Caerpillar Inc., Peoria, IL (US)

(21) Appl. No.: 14/629,497

(22) Filed: Feb. 24, 2015

(51) Int. Cl. F01M 1/12; F02F 1/20

(52) U.S. Cl. CPC F01M 1/12; F02F 1/20

(57) ABSTRACT

A lubrication system for an engine is disclosed. The engine has a cylinder block that includes a face portion and an oil gallery. The lubrication system includes one or more oil passages that extend between the oil gallery and the face portion. The oil passages include a lubrication port, a first channel, a second channel, and a third channel. The lubrication port is defined at interface of the oil passages and the face portion of the cylinder block. Each of the first channel, the second channel, and the third channel extends from the previous channel in a sequential manner and has a first end and a second end. The first channel extends in a substantially horizontal direction from the lubrication port. The second channel extends in a substantially vertical direction from the first channel. The third channel is connected to the oil gallery.

### TECHNICAL FIELD

The present disclosure relates generally to a lubrication system for engines. More specifically, the present disclosure relates to oil passages of the lubrication system that prevents debris entry into the engine.

### BACKGROUND

Various engines, such as an internal combustion engine, commonly employ a lubrication system to lubricate various components of the engine. These components may include but are not limited to, a camshaft bearing, a crankshaft bearing, and/or elements of a cylinder head. Generally, these components are installed with a cylinder block and are supplied with lubrication oil by the lubrication system. The lubrication system supplies lubrication oil to these components through the cylinder block of the engine. For this purpose, the lubrication system includes an oil gallery and a number of oil passages defined within the cylinder block of the engine that facilitate flow of lubrication oil to the components of the engine connected to the cylinder block. Each of the oil passages bifurcate from the oil gallery and extend towards the components of the engine installed with the cylinder block. This facilitates flow of lubrication oil to the components of the engine installed with the cylinder block.

During service and/or repair of the engine, one or more components of the engine, such as the cylinder head, are disassembled from the cylinder block and the oil passages are exposed to the external environment. In such situations, dust and debris may enter the oil passages defined within the cylinder block. As the oil passages in conventional lubrication systems are generally vertically oriented, the dust and debris may flow into the oil gallery. This may lead to oil contamination and flow of debris material to other components of the engine, when reused. This may damage the components and may lead to component failure.

Japanese Patent Application 2,009,162,194 discloses a lubrication structure of an internal combustion engine that prevents intrusion of foreign matter (debris) into an oil passage that supplies lubrication oil to a required portion (components of the engine). This is accomplished by shortening the oil passage leading from an oil filter to the required portion (various components of the engine). Although this reference discloses the lubrication structure that prevents intrusion of foreign matter (debris) into the oil passage by shortening the oil passage, no reference provides a solution that prevents intrusion of foreign matter (debris) into the oil passage by variation in a geometry of the oil passages.

### SUMMARY OF THE INVENTION

Various aspects of the present disclosure illustrate a lubrication system for an engine. The engine has a cylinder block. The cylinder block has a face portion and an oil gallery. The oil gallery is routed along a length of the cylinder block. The lubrication system includes one or more oil passages that extend between the oil gallery and the face portion. The oil passages include a lubrication port, a first channel, a second channel, and a third channel. The lubrication port is positioned at an interface of the one or more oil passages and the face portion of the cylinder block. The first channel extends in a substantially horizontal direction from the lubrication port. The first channel has a first end and a second end. The first end of the first channel is connected to the lubrication port. The second channel extends in a substantially vertical upward direction relative to the first channel. The second channel has a first end and a second end. The first end of the second channel extends from the second end of the first channel. The third channel has a first end and a second end. The first end of the third channel extends from the second end of the second channel. The second end of the third channel is connected to the oil gallery.

### BRIEF DESCRIPTION OF THE DRAWINGS

FIG. 1 is a cross-sectional view of a cylinder block of an engine that illustrates a lubrication system that includes an oil gallery and a number of oil passages, in accordance with the concepts of the present disclosure; and

FIG. 2 is a cross-sectional view of cylinder block of the engine that illustrates a camshaft lubrication passage and a crankshaft lubrication passage of the lubrication system of FIG. 1, in accordance to the concepts of the present disclosure.

### DETAILED DESCRIPTION

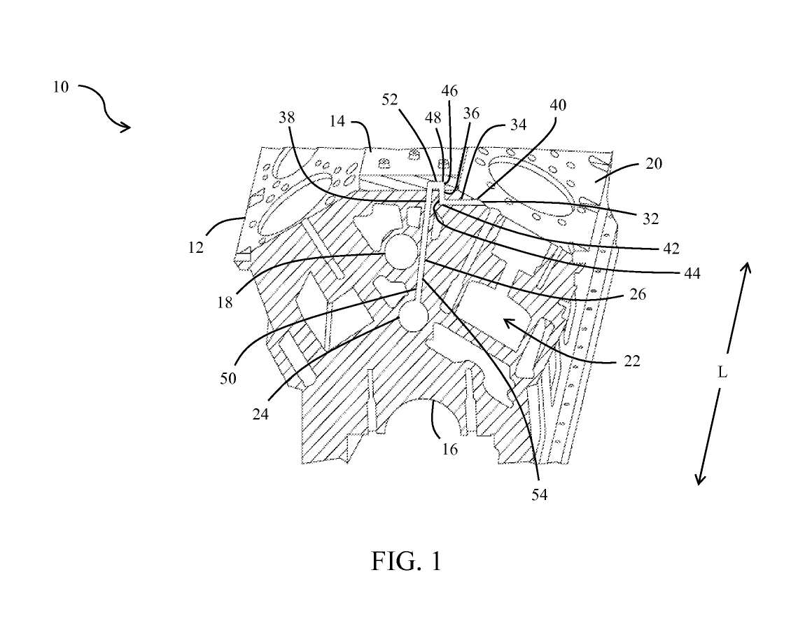

Referring to FIG. 1, there is shown a cross-sectional view of a cylinder block 12 of an engine 10. The engine 10 may be one of a spark ignition type and/or a compression ignition type. Other engine types may also be contemplated. Although, in the present disclosure, a ‘V-layout’ configuration of the engine 10 is shown as a preferred embodiment, other configurations of the engine 10, such as an ‘in-line layout’ configuration, may also be contemplated. The engine 10 is commonly known to employ at least one piston (not shown), a cylinder arrangement (not shown), and various other components, that work in conjunction with each other to produce motive power required to run the machine. Furthermore, the engine 10 includes the cylinder block 12 and a lifter cover 14 attached to the cylinder block 12.

The cylinder block 12 is structured and arranged to house the piston (not shown) and the cylinder arrangement (not shown) of the engine 10. The cylinder block 12 generally provides a mounting base for various components of the engine 10, such as but not limited to, a camshaft bearing, a crankshaft bearing, and/or a cylinder head. For example, the cylinder block 12 defines a crankshaft bearing space 16 to mount the crankshaft bearing (not shown), a camshaft bearing space 18 to mount the camshaft bearing (not shown), and a face portion 20 to mount the cylinder head (not shown) of the engine 10.

Furthermore, the engine 10 is equipped with a lubrication system 22 to lubricate the components (the camshaft bearing, the crankshaft bearing, and elements of the cylinder head) attached to the cylinder block 12 of the engine 10. As is customarily known, the elements of the cylinder head (not shown) may include, but are not limited to, an intake valve, an exhaust valve, and/or a rocker arm. For lubrication of the elements of the cylinder head (not shown) of the engine 10, the lubrication system 22 supplies lubrication oil to the cylinder head (not shown) of the engine 10 through the cylinder block 12. For this purpose, the lubrication system 22 includes a main oil gallery 24, hereafter referred to as oil gallery 24 and one or more oil passages 26, defined within the cylinder block 12 of the engine 10. The oil gallery 24 and the oil passages 26 in conjunction facilitate a flow of lubrication oil through the cylinder block 12 to the cylinder head (not shown) of the engine 10. This may facilitate lubrication of the elements of the cylinder head (not shown) of the engine 10.

The oil gallery 24 is defined within the cylinder block 12 and is routed in a fore-aft direction, along a length ‘L’ of the cylinder block 12. Each of the oil passages 26 extend from the oil gallery 24 towards the face portion 20 of the cylinder block 12, to connect with the cylinder head (not shown) of the engine 10. This enables a fluid connection between the oil gallery 24 and the cylinder head (not shown) of the engine 10 via the oil passages 26. Therefore, the oil passages 26 facilitate flow of lubrication oil from the oil gallery 24 to the cylinder head (not shown) of the engine 10, for lubrication. Although, a singular oil passage 26 is shown in the cross-section depicted in FIG. 1, it may be contemplated that multiple similar oil passages 26 may extend from the oil gallery 24 at several cross-sections of the cylinder block 12 taken along the length ‘L’ of the cylinder block 12. Concepts of the present disclosure may also be applicable to those oil passages 26 that extend from the oil gallery 24, at several cross-sections of the cylinder block 12. The oil passages 26 include a lubrication port 32, a first channel 34, a second channel 36, and a third channel 38.

The lubrication port 32 is defined at an interface between the oil passages 26 and the face portion 20 of the cylinder block 12. It may be noted that the lubrication port 32 facilitates a fluid connection between the oil passages 26 and the cylinder head (not shown) of the engine 10.

The first channel 34 extends in a substantially horizontal direction from the lubrication port 32, and includes a first end 40 and a second end 42. The first end 40 of the first channel 34 connects to the lubrication port 32 of the oil passages 26.

The second channel 36 includes a first end 44 and a second end 46. The first end 44 of the second channel 36 extends from the second end 42 of the first channel 34. Notably, the second channel 36 extends in a substantially vertical upward direction relative to the first channel 34. Therefore, the second end 46 of the second channel 36 is at relatively higher potential than the first end 40 and the second end 42 of the first channel 34. During engine service, the lubrication port 32 may be exposed to external environment and dust and/or debris may enter the first channel 34. In an exemplary embodiment, the second channel 36 may have sufficient volume to prevent debris in the first channel 34 from being flushed into the third channel 38 during drainage of the lubrication system 22, when the engine 10 is shut down.

The third channel 38 includes a first end 48 and a second end 50. The first end 48 of the third channel 38 extends from the second end 46 of the second channel 36. The second end 50 of the third channel 38 is connected to the oil gallery 24. In an exemplary embodiment, as shown in FIG. 1, the third channel 38 consists of two sub-channels denoted by a first sub-channel 52 and a second sub-channel 54. The first sub-channel 52 is defined within the lifter cover 14 and includes the first end 48 of the third channel 38. The first sub-channel 52 extends in a horizontal direction. The second sub-channel 54 includes the second end 50 of the third channel 38, and extends in a substantially vertical direction towards the oil gallery 24. It may be noted that the oil passages 26 facilitate the flow of lubrication oil in a sequential manner from the oil gallery 24 to the cylinder head (not shown) of the engine 10, through the third channel 38, the second channel 36, the first channel 34, and the lubrication port 32.

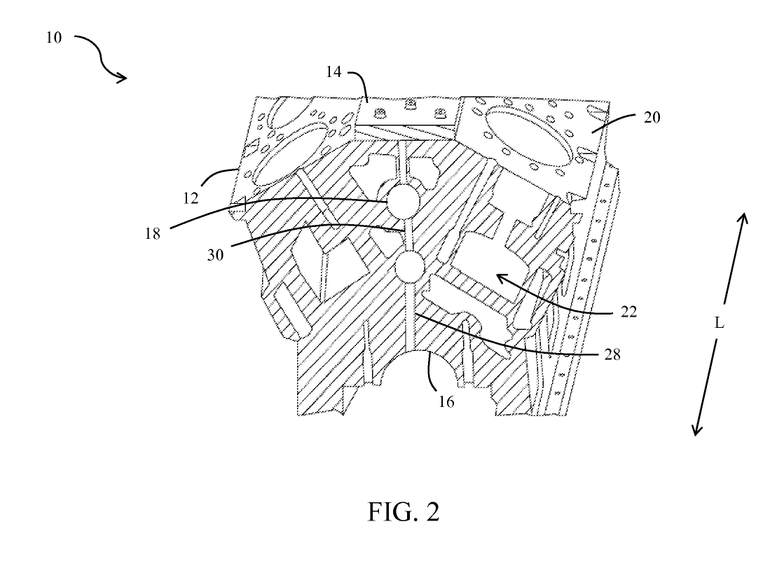

Referring to FIG. 2, there is shown the cross-sectional view of the engine 10 that illustrates a crankshaft lubrication passage 28 and a camshaft lubrication passage 30 respectively for lubrication of the crankshaft bearing not shown) and the camshaft bearing (not shown). The crankshaft lubrication passage 28 bifurcate from the oil gallery 24 and extend towards the crankshaft bearing space 16. This facilitates a fluid connection between the oil gallery 24 and the crankshaft bearing space 16, where the crankshaft bearing (not shown) may be connected. Therefore, the crankshaft lubrication passage 28 facilitate a supply of lubrication oil to the crankshaft bearing (not shown) of the engine 10. Similarly, the camshaft lubrication passage 30 bifurcate from the oil gallery 24 and extend towards the camshaft bearing space 18. This facilitates a fluid connection between the oil gallery 24 and the camshaft bearing space 18 of the cylinder block 12, where the camshaft bearing (not shown) may be connected. Therefore, the camshaft lubrication passage 30 facilitate a flow of lubrication oil to the camshaft bearing (not shown). Although concepts of the present disclosure are directed towards the structure of the oil passages 26 (FIG. 1), it may be noted that the concepts of the present disclosure may also be applicable to the crankshaft lubrication passage 28 and the camshaft lubrication passage 30.

### INDUSTRIAL APPLICABILITY

During normal operation, the lubrication system 22 supplies lubrication oil to the components (the crankshaft, the camshaft, and the cylinder head) attached to the cylinder block 12 of the engine 10. More specifically, the lubrication system 22 includes an oil pump that circulates lubrication oil to these components through the cylinder block 12 of the engine 10. In this process, the lubrication oil is initially supplied to the oil gallery 24 of the lubrication system 22. From the oil gallery 24, the lubrication oil is transferred to the components (the crankshaft, the camshaft, and the cylinder head) attached to the cylinder block 12 of the engine 10. In an embodiment, the oil passages 26 facilitate the supply of lubrication oil from the oil gallery 24 to the cylinder head (not shown) of the engine 10. The crankshaft lubrication passage 28 facilitate the supply of lubrication oil from the oil gallery 24 to the crankshaft bearing (not shown) of the engine 10. The camshaft lubrication passage 30 facilitate the supply of lubrication oil from the oil gallery 24 to the camshaft bearing (not shown) of the engine 10. This facilitates lubrication of the crankshaft bearing (not shown), the camshaft bearing (not shown), and the elements of the cylinder head (not shown) of the engine 10.

During service and/or repair of the engine 10, these components (the crankshaft, the camshaft, and the cylinder head) are disassembled from the cylinder block 12 of the engine 10. More specifically, the cylinder head (not shown) is disassembled from the cylinder block 12 of the engine 10, during service and/or repair of the engine 10. In such situations, the lubrication port 32 of the oil passages 26 are exposed to the external environment. This may cause dust and debris to be introduced to the lubrication port 32 of the oil passages 26. As the first channel 34 is in horizontal orientation, dust and debris may enter the first channel 34 of the oil passages 26. Further, as the second channel 36 of the oil passage 26 is in vertical orientation, entry of dust and debris into the second channel 36 of the oil passage 26 may be restricted due to gravity. Therefore, dust and debris are prevented from entering the oil gallery 24 of the lubrication system 22 and are restricted within the first channel 34 and/or the second channel 36. The dust and debris that entered the first channel 34 may then be cleaned out, before the components are reassembled for being reused. Thus, the components (the crankshaft, the camshaft, and the cylinder head) attached to the cylinder block 12 of the engine 10 are supplied with uncontaminated lubrication oil during reuse of the lubrication system 22. This may improve life of the components (the crankshaft, the camshaft, and the cylinder head) that are lubricated by the lubrication oil.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A lubrication system for an engine, the engine having a cylinder block, the cylinder block having a face portion and an oil gallery, the oil gallery being routed along a length of the cylinder block, the lubrication system comprising:
one or more oil passages extending between the oil gallery and the face portion, the one or more oil passages including:
a lubrication port at an interface of the one or more oil passages and the face portion of the cylinder block;
a first channel extending in a substantially horizontal direction from the lubrication port, the first channel having a first end and a second end, the first end of the first channel being connected to the lubrication port;
a second channel having a first end and a second end, the first end of the second channel extending from the second end of the first channel, the second channel extending in a substantially vertical upward direction relative to the first channel; and
a third channel having a first end and a second end, the first end of the third channel extending from the second end of the second channel, the second end of the third channel being connected to the oil gallery.
